(19) United States
(12) Patent Application Publication
(10) Pub. No.: US 2013/0319656 A1
(43) Pub. Date: Dec. 5, 2013

(54) ENZYME BREAKERS AND METHODS FOR FLUID SYSTEMS

(71) Applicant: Duane Kevin Brownlee, Calgary (CA)

(72) Inventor: Duane Kevin Brownlee, Calgary (CA)

(73) Assignee: Trican Well Service Ltd., Alberta (CA)

(21) Appl. No.: 13/878,055

(22) PCT Filed: Oct. 6, 2011
(86) PCT No.: PCT/CA11/01118

§ 371 Date: Aug. 14, 2013

Related U.S. Application Data
(60) Provisional application No. 61/390,316, filed on Oct. 6, 2010.

(51) Int. Cl. C09K 8/62; E21B 43/267

(52) U.S. Cl. CPC C09K 8/62; E21B 43/267
USPC 166/246; 507/201; 166/308.1

(57) ABSTRACT

This invention relates to slurry compositions and their use in oil field applications. In particular, this invention is directed to slurry compositions comprising non-saccharide polymers (for use as thickeners and/or friction reducers) and enzymatic breakers, as well as methods of using such slurry compositions as fracturing fluids in slickwater fracturing operations in low permeable rock formations.

### FIELD OF THE INVENTION

This invention relates to slurry compositions and their use in oil field applications. In particular, this invention is directed to slurry compositions comprising non-saccharide polymers (for use as thickeners and/or friction reducers) and enzymatic breakers, as well as methods of using such slurry compositions as fracturing fluids in low permeable rock formations.

### BACKGROUND

Since the middle of the 20th Century, hydraulic fracturing has been used to enhance the production of oil and gas wells and thereby reduce their ‘pay back’ period. Historically this was accomplished by first initiating and then extending a fracture in a hydrocarbon bearing formation and then propping this fracture open with proppants, such as sand.

To facilitate both the extension of the fractures in the rock (by reducing the loss of the base fluid to the formation) and the carrying of the proppants into the fracture, fluids thickened with polymers are commonly used. For conventional wells, the most common fluid systems are aqueous (i.e. water) based fluids thickened with naturally occurring polymers (i.e. the polymers increase the viscosity of the fluid, thus also acting as friction reducers). The most commonly used naturally occurring polymers are guar and derivatives thereof which consist of repeating units of natural occurring sugars (saccharides). To assist in the removal of the fracturing fluid and the polymers used to thicken the fluid, compounds known as ‘breakers’ are normally added to the fluid prior to pumping. Breakers function to reduce the length of the polymer molecule thereby facilitating the removal of the molecule from the fracture. Two common forms of breakers used in fluids systems thickened with naturally occurring polymers are chemical oxidizers (chemicals which are analogous to bleach in their mechanism of action) and biologically active enzymes. By their nature, oxidizers work by either providing an electron or adding an oxygen atom to a linkage and thereby breaking the linkage which, in the process, uses up the molecule which contributed the oxygen. In this way the effectiveness of the breaker is subject to the stochiometric nature of the reaction. In addition, due to the unspecific nature of these highly reactive chemicals, some portion of the oxidizer chemical end up reacting with other materials in the fracture, whether these other materials be the rock, proppant, tubulars or the hydrocarbon itself. By contrast, enzymes are by their nature highly specific catalysts. This means that their sole function is to facilitate the occurrence of a relatively specific reaction and are not used up in the process and can continue to react as long as the chemical environment permits it to retain its chemical activity (i.e. by retaining its active folding or shape).

Since the beginning of the 21st Century it has become common to perform hydraulic fractures in ‘unconventional reservoirs’ (shale and other similarly low permeability rock formations) often using synthetic (i.e. man made) polymers, such as polyacrylamide or others, at relatively low concentrations compared to the concentrations of naturally occurring polymers used in conventional fracturing operations, to reduce the friction generated by the very high pump rates. High pump rates are necessary to carry the sand at low polymer concentrations and to stay ahead of the rate of fluid loss into the formation. The historic wisdom in the well completion industry was that the polyacrylamide gels could not be broken through the use of conventional breakers. Nonetheless, relatively simple oxidizer breakers were found to be moderately effective at reducing the molecular weight of the polymer, for example, see U.S. Pat. No. 7,621,335 to Valeriano et al. These simple oxidizers are now commonly used as breakers in well treating fluids useful in slickwater fracturing processes. These breakers have limited effectiveness due to the same stoichiometric limitations and possible loss of breaker to the other constituents in the fracture as previously mentioned. This potential problem of unbroken polymer and resultant damage to the fracture and formation face is further compounded by the nature of the fractures being performed. Given the very long length (100 meters or more) of fracture length, it is very difficult to ensure that there is sufficient drawdown (difference in pressure between the adjacent formation and the inside of the fracture due to production of fluids from this portion of the fracture).

Additional potential concerns with the use of polyacrylamide and other similar synthetic polymers, for example, non-saccharide polymers, in fracturing fluids and the use of oxidizer breakers to degrade them are (1) that a likely product of these reactions is the base unit of the polymer, acrylamide in the case of polyacrylamide, which is known to be toxic. If sufficient quantities of acrylamide or other base units are liberated, the fluid recovered from the fracture would also have to be considered toxic, and (2) that gels with partially broken polymer are difficult to recycle as fracturing fluids. Therefore, it would be desirable to have a breaker and a method of breaking down non-saccharide polymers such as polyacrylamide.

Multiple species of microbes and fungi have been demonstrated to be capable of degrading polyacrylamide and/or polyacrylate (a likely degradation of polyacrylamide) from different sources. For example, see Wen, Q., et al. “Biodegradation of polyacrylamide by bacteria isolated from activated sludge and oil-contaminated soil” J Hazard Mater. 2010 Mar. 15; 175(1-3):955-9 (Epub 2009 Oct. 30), Kay-Shoemake, et al. “Polyacrylamide as a substrate for microbial amidase in culture and soil”, Soil Biology and Biochemistry, Volume 30, Issue 13, November 1998, Pages 1647-1654, and Hayashi, T., et al., “Degradation of a sodium acrylate oligomer by an Arthrobacter sp.”, Appl Environ Microbiol. 1993 May; 59(5):1555-9.

### SUMMARY OF THE INVENTION

While it is known to utilize oxidizing chemicals or enzymes as breakers in fracturing fluids comprising conventional, saccharide polymer thickeners, only oxidizing breakers have been used to break non-saccharide based or synthetic based polymer based fluids.

According to one aspect of the present invention there is provided a slurry composition for a hydraulic fracturing operation in subterranean formations comprising a carrier fluid, non-saccharide polymers (the polymers function as a thickener and/or friction reducer), and one or more breakers. The breakers are present to degrade the polymers once the aqueous fluid is pumped down hole. The breakers are selected from the group consisting of one or more enzymes able to degrade the non-saccharide polymers, microbes able to degrade the non-saccharide polymers, fungi able to degrade the non-saccharide polymers and combinations thereof.

According to a further aspect of the present invention, there is provided a method of hydraulically fracturing a subterranean formation comprising the steps of:
(a) mixing proppants, one or more non-saccharide polymers, and a breaker into a carrier fluid to form a viscous slurry composition;
(b) injecting the slurry composition from step (a) down a wellbore into the subterranean formation at a pressure sufficient to initiate fracturing;
(c) the breakers degrade the non-saccharide polymers to reduce the viscosity of the slurry composition to allow the slurry composition to flow back out of the wellbore;

whereby the breaker is selected from the group consisting of: one or more enzymes able to degrade the non-saccharide polymers, microbes able to degrade the non-saccharide polymers, fungi able to degrade the non-saccharide polymers and combinations thereof.

### DETAILED DESCRIPTION OF EMBODIMENTS

In an embodiment of the present invention, a slurry composition, in particular, a fracturing fluid, is prepared by blending a proppant, a thickener and/or friction reducer (i.e. gel) and a carrier fluid together. In a preferred embodiment, the slurry composition is for use in a slickwater fracturing operation. The proppant can be any type of proppant used in the well oil industry and would be readily known to the person skilled in the art. For example, the proppants can be sand, resin coated sand, synthetic polymeric beads, ceramic, carbonate, bauxite, shale, coal particulates, or combinations thereof. Typically the proppant is sand, either natural or man-made. The gel or polymer in this embodiment of the invention is polyacrylamide, but it can be any other suitable non-saccharide based polymer or synthetic polymer. In a preferred embodiment, the fluid is only slightly thickened with the non-saccharide polymer. The carrier fluid can be nitrogen, carbon dioxide, water, or other known fluids that are commonly used in well completion procedures. In a preferred embodiment, the carrier fluid is water. The blending apparatus is conventional equipment commonly used in the oil and gas well servicing and completions industries and is well known. The resultant fluid composition can be used in slickwater fracturing operations (slickwater fracs), with a viscosity in the range of a few centipoises, approximately 1.5-5 times more viscous than water; and mixed into the range with a pH between about 3 to about 12. In a preferred embodiment, the resulting fluid composition will have neutral pH. In other words, in an embodiment of the present invention, the fluid compositions are used in slickwater, non-acidizing fracturing operations.

To facilitate the breaking of the gel/thickener, which consists of non-saccharide based polymers including polyacrylamide and synthetic polymers, enzymes specific for the polymer (or microbes or fungi known to, or adapted to, degrade such polymers) are added to the fracturing fluid when the fracturing fluid is blended. The enzymes, microbes and/or fungi are added to the fracturing fluids for the specific purpose of degrading the polymer thickener/friction reducer in the fracturing fluid to reduce the fluid's viscosity and thus facilitate cleanup of the fracture. Typically the fluid is blended just prior to being pumped downhole. Enzymes suitable for use in the invention can be isolated from the microbes or fungi that are naturally capable of degrading one or more of the non-saccharide based polymer; the enzymes can be isolated from other microbes or fungi which have had genes which encode enzymes which are capable of degrading one or more man made polymers spliced into their own genetic code; or the enzymes of interest can be synthesized chemically.

The enzyme classes that could be used, depending on the polymer(s) used in the fluid, include deaminases, dehydrogenases, oxidases, reductases, phosphorylases, aldolases, synthetases, hydrolases and hydroxyethylphosphonate dioxygenases. More than one enzyme may be used in the fluid compositions of the present invention.

The conditions of typical surface operations, where blending of the fracturing fluid takes place, are often quite different to the conditions downhole. For example, downhole conditions are generally warmer than surface conditions. It is possible to have enzymes that are relatively inactive at surface temperatures, such that the polymer is not degraded by the enzyme when the enzyme and polymer are blended with the proppant and carrier fluid. The resulting fracturing fluid is pumped down the wellbore and into the formation to fracture the rock, thus stimulating the well. The subterranean formations are typically “tight” formations, with low permeability; commonly within the range of 0.01 to 50 microdarcies (μD). Examples of this kind of formation are shales, such as those found in Northeastern British Columbia and the Northeastern United States. Typically these formations are not carbonates, and as such are not responsive to acidizing, or acid fracturing operations. Thus the blended fluids pumped into these kinds of formations are not required to have acid tolerance.

Once proppant is deposited into the cracks in the subterranean formations that were formed by the hydraulic fracturing operation, it is desirable to have the polymer removed as completely as possible to leave only the proppant in place. With one or more enzymes, and/or one or more microbes or fungi, mixed with one or more non-saccharide based polymers according to the present invention, it is possible for the enzymes to begin degrading the polymer as soon as they are in contact. As noted, this process is generally retarded at surface temperatures, but can proceed at a much more advanced pace in the elevated temperatures that are typically present in downhole conditions. If the surface temperature and the temperature downhole are relatively the same, it is also possible to delay the activity of the enzyme. The use of capsules to mask, protect, stabilize, delay or control the release of breakers is well known and, in particular, the use of such capsules or microcapsules to encapsulate breaker materials has been described in, e.g., U.S. Pat. No. 4,202,795 to Burnham, et al.; U.S. Pat. No. 4,506,734 to Nolte; U.S. Pat. No. 4,741,401 to Walker et al; U.S. Pat. No. 4,919,209 to King; U.S. Pat. No. 5,110,486 to Manalastar et al; U.S. Pat. Nos. 5,102,558; 5,102,559; 5,204,183 and 5,370,184 all to McDougall et al; U.S. Pat. Nos. 5,164,099 and 5,437,331 to Gupta et al; and U.S. Pat. No. 5,373,901 to Norman et al. By coating the solid enzymes in a suitable ‘time released’ substance, the activity can be delayed.

Without being bound by theory, given their catalytic nature, enzymes will act—in this case cleaving the units making up the polyacrylamide or other synthetic polymer—so long as the chemical environment in which they are suspended continues to be within their range of tolerance. The remains from the degraded polymer will then be carried to the wellbore by either or both the base fluid (i.e. carrier fluid) used to carry the proppant or the naturally occurring fluids in the formation.

The fracturing fluid and polymer remains, as well as any proppant that was not inserted into the formation, are washed and removed from the wellbore during the stage of the well completion procedure called flowback. This is a process that lowers the pressure on the wellhead to allow the subterranean formation to produce hydrocarbon after a predetermined amount of time subsequent to the hydraulic fracturing operation. The amount of time that the well is shut in after the hydraulic fracturing operation is to allow the enzymes to degrade the polymer, and to assist the action of a chemical breaker (if such is also used) in its degradation and consumption of the polymer. The amount of time required will depend upon the enzymes concentration, polymer amounts, downhole temperature, salt concentration in the wellbore fluids, pH of the wellbore fluids and many other factors. After an appropriate amount of time has passed, the wellhead valve is opened and the well allowed to flow, or produce to clear the wellbore. The well may be produced into a tank, a pipeline or other means, and the fluids and excess proppant are recovered, separated and treated. Typically the flowrates are measured and the performance of the well can be determined. The remains of the fracturing fluids are separated from any hydrocarbons, and can be treated for further use, or disposed of at a suitable facility.

One advantage of the present invention, is that the enzymes are a catalyst and can enter and leave reactions without being consumed and further extend their usefulness until the polyacrylamide is nearly or completely consumed. A disadvantage of the prior art is that the polymers are broken by chemical means, and the reaction stops when the breaker is exhausted or depleted, or is not present in a sufficient concentration to be effective. The enzymes can continue breaking the polymer until the polymer is completely degraded, and as such provide dynamic and flexible amounts of breaking power, compared to a fixed amount of breaking that can be accomplished by the prior art chemical means. This provides a much greater probability of a successful breaking operation than prior art chemical means, as the amount of chemical breaker added is subject to human error, mixing errors, shortages, spillage, etc. and it is quite likely that an incorrect amount of breaker is blended with the fracturing fluid. The use of enzymes provides some forgiveness to these sorts of errors, and can allow a more complete breaking in the event of measuring errors.

A person skilled in the art would also appreciate that the fluid compositions of the present invention may also comprise various other fluid additives known in the art, for example, pH buffers, biocides, mineral stabilizers, breaker stabilizers, solvents, crystal modifiers, emulsifiers, demulsifiers and surfactants.

The preceding description of specific embodiments for the present invention is not intended to be a complete list of every embodiment of the invention. Persons who are skilled in this field will recognize that modifications can be made to the specific embodiments described herein that would be within the scope of the invention.

1. A slurry composition for a hydraulic fracturing operation in subterranean formations comprising:
a carrier fluid;
non-saccharide polymers to function as a thickener and/or friction reducer; and
one or more breakers for degrading the polymers once the aqueous fluid is pumped down hole, wherein the breaker is selected from the group consisting of: one or more enzymes able to degrade the non-saccharide polymers, microbes able to degrade the non-saccharide polymers, fungi able to degrade the non-saccharide polymers and combinations thereof.

2. The slurry composition according to claim 1, wherein the non-saccharide polymers comprises polyacrylamide.

3. The slurry composition according to claim 1, wherein the breaker comprises one or more enzymes.

4. The slurry composition according to claim 3, wherein the one or more enzymes is selected from the classes consisting of deaminases, dehydrogenases, oxidases, reductases, phosphorylases, aldolases, synthetases, hydrolases, hydroxyethylphosphonate dioxygenases, and combinations thereof.

5. The slurry composition according to claim 4, wherein the composition has a pH in the range of about 3 to about 12.

6. The slurry composition according to claim 5, wherein the slurry composition further comprises proppant.

7. The slurry composition according to claim 6, wherein the proppant is selected from the group consisting of: sand, resin coated sand, synthetic polymeric beads, ceramic, carbonate, bauxite, shale, coal particulates and combinations thereof.

8. The slurry composition according to claim 7, wherein the composition has a viscosity in the range of a few centipoises.

9. The slurry composition according to claim 8, wherein the carrier fluid is selected from the group consisting of nitrogen, carbon dioxide, water, and combinations thereof.

10. The slurry composition according to claim 9, wherein the breaker further comprises a time release substance.

11. The slurry composition according to claim 1, wherein the slurry composition is suitable for use in a slickwater hydraulic fracturing operation.

12. The slurry composition according to claim 11, wherein the slurry composition is suitable for use in a slickwater fracturing operation in low permeable rock formations.

13. A method of hydraulically fracturing a subterranean formation comprising the steps of:
(a) mixing proppants, one or more non-saccharide polymers, and a breaker into a carrier fluid to form a viscous slurry composition;
(b) injecting the slurry composition from step (a) down a wellbore into the subterranean formation at a pressure sufficient to initiate fracturing;
(c) the breakers degrade the non-saccharide polymers to reduce the viscosity of the slurry composition to allow the slurry composition to flow back out of the wellbore;
whereby the breaker is selected from the group consisting of: one or more enzymes able to degrade the non-saccharide polymers, microbes able to degrade the non-saccharide polymers, fungi able to degrade the non-saccharide polymers and combinations thereof.

14. The method according to claim 13, wherein the polymer comprises polyacrylamide.

15. The method according to claim 13, wherein the breaker is one or more enzymes.

16. The method according to claim 13, wherein the one or more enzymes is selected from the class consisting of deaminases, dehydrogenases, oxidases, reductases, phosphorylases, aldolases, synthetases, hydrolases, hydroxyethylphosphonate dioxygenases and combinations thereof.

17. The method according to claim 16, wherein the composition has a pH in the range of about 3 to about 12.

18. The method according to claim 17, wherein the proppant is selected from the group consisting of: sand, resin coated sand, synthetic polymeric beads, ceramic, carbonate, bauxite, shale, coal particulates and combinations thereof.

19. The method according to claim 18, wherein the composition has a viscosity in the range of a few centipoises.

20. The method according to claim 19, wherein the carrier fluid is selected from the group consisting of nitrogen, carbon dioxide, water, and combinations thereof.

21. The method according to claim 20, wherein the breaker further comprises a time release substance.

22. The method according to claim 13, wherein the subterranean formation consists of low permeable rock.

23. The method according to claim 22, wherein the low permeable rock is shale.

24. The method according to claim 13, wherein the hydraulic fracturing operation is a slickwater fracturing operation.
